(19) United States
(12) Patent Application Publication
(10) Pub. No.: US 2025/0093237 A1
(43) Pub. Date: Mar. 20, 2025

(54) SOUND DIAGNOSTIC SYSTEM, SOUND DIAGNOSTIC METHOD, AND NON-TRANSITORY COMPUTER-READABLE RECORDING MEDIUM

(71) Applicant: Konica Minolta, Inc., Tokyo (JP)

(72) Inventor: Kenji ONO, Toyokawa-shi (JP)

(21) Appl. No.: 18/824,685

(22) Filed: Sep. 4, 2024

(30) Foreign Application Priority Data
Sep. 19, 2023 (JP) 2023-150743

(51) Int. Cl. G01M 99/00; G01H 17/00; G10L 25/51

(52) U.S. Cl. CPC G01M 99/005; G01H 17/00; G10L 25/51

(57) ABSTRACT

A sound diagnostic system includes one or more hardware processors, and one or more memories storing instructions that cause the one or more hardware processors to perform operations. The operations include: calculating, from sound information on a sound produced by an apparatus, a sound pressure of each of a plurality of frequencies at each timing; calculating an autocorrelation function for a change, with time, of a representative value of the sound pressures of respective frequencies included in a target frequency band; detecting a period of each of one or more abnormal sounds, based on the one or more peak timings; and identifying, based on the period, a causative component for each of the one or more abnormal sounds, among a plurality of components included in the apparatus.

### CROSS-REFERENCE TO RELATED APPLICATIONS

The entire disclosure of Japanese Patent Application No. 2023-150743 filed on Sep. 19, 2023 is incorporated herein by reference in its entirety.

### BACKGROUND

### Technological Field

The present disclosure relates to a sound diagnostic system, and more specifically, to a sound diagnostic system using the sound pressure.

### Description of the Related Art

In a case where an apparatus such as a home appliance used at home or an image forming apparatus used in an office breaks down, the apparatus may produce an abnormal sound. A serviceperson can identify a faulty component from the abnormal sound and replace the faulty component. However, in a case where an apparatus including a plurality of motors or the like breaks down, it is difficult for a serviceperson to specify which component of the apparatus is producing the abnormal sound. In this case, the serviceperson cannot specify which component should be repaired or replaced. Therefore, there is a need for a sound diagnostic technology for easily identifying a component producing an abnormal sound in an apparatus.

Regarding a sound diagnosis, for example, Japanese Laid-Open Patent Publication No. 2017-138151 discloses a “diagnostic apparatus” that supports a task of identifying a cause of an abnormal sound. The diagnostic apparatus identifies the frequency of the abnormal sound in frequency spectrum waveform data. The diagnostic apparatus performs a fast Fourier transform on a frequency component of the abnormal sound, in the time axis direction, to extract information on the period and the frequency of the abnormal sound. The extracted information is used for identifying the cause of the abnormal sound.

Japanese Laid-Open Patent Publication No. H04-167699 discloses a “rattling sound detection apparatus.” The apparatus obtains an autocorrelation function of a time waveform of a sound. The apparatus determines whether an abnormality is present or not, based on a result of comparison between a peak value of the autocorrelation function and a predetermined value.

### SUMMARY

An apparatus having a complicated mechanism, such as an image forming apparatus, includes a plurality of components that generate a drive sound. The plurality of components may include a component that may generate an abnormal sound having a plurality of frequency components. Alternatively, the plurality of components may include a component that may generate an abnormal sound multiple times or an abnormal sound having a certain time width, during one rotation. The apparatus disclosed in Japanese Laid-Open Patent Publication No. 2017-138151 is not able to accurately detect the period of the abnormal sound of such a component. As a result, the apparatus disclosed in Japanese Laid-Open Patent Publication No. 2017-138151 is not able to accurately identify a causative component that causes the abnormal sound.

The apparatus disclosed in Japanese Laid-Open Patent Publication No. H04-167699 merely determines whether an abnormality is present or not, and does not identify a causative component that causes the abnormal sound.

An object in one aspect of the present disclosure is to provide a technology that enables a causative component causing an abnormal sound to be identified among a plurality of components.

To achieve at least one of the abovementioned objects, according to an aspect of the present invention, a sound diagnostic system reflecting one aspect of the present invention comprises: one or more hardware processors; and one or more memories storing instructions that, when executed by the one or more hardware processors, cause the one or more hardware processors to perform operations. The operations include: calculating, from sound information on a sound produced by an apparatus, a sound pressure of each of a plurality of frequencies at each timing; calculating an autocorrelation function for a change, with time, of a representative value of the sound pressures of respective frequencies included in a target frequency band, among the plurality of frequencies; extracting one or more peak timings of the autocorrelation function; detecting a period of each of one or more abnormal sounds, based on the one or more peak timings; and identifying, based on the period, a causative component for each of the one or more abnormal sounds, among a plurality of components included in the apparatus.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 is a diagram illustrating an example of a configuration of a sound diagnostic system to which the technology of the present disclosure can be applied.

FIG. 2 is a diagram illustrating an example of a configuration of a sound diagnostic system according to Embodiment 1.

FIG. 3 is a diagram illustrating an example of a procedure of a diagnostic process performed by the sound diagnostic system according to Embodiment 1.

FIG. 4 is a diagram illustrating an example of sound information.

FIG. 5 is a diagram illustrating an example of a spectrogram.

FIG. 6 is a diagram illustrating an example of data on an overall sound pressure of a target frequency band for each timing in a spectrogram.

FIG. 7 is a diagram illustrating an example of an autocorrelation function.

FIG. 8 is a diagram illustrating an example of peak timing information.

FIG. 9 is a diagram illustrating an example of prominences of peaks of an autocorrelation.

FIG. 10 is a diagram illustrating an example of period information.

FIG. 11 is a diagram illustrating an example of result information indicating causative components identified by an identification unit.

FIG. 12 is a diagram illustrating an example of a first screen output by an output unit.

FIG. 13 is a diagram illustrating an example of a second screen output by the output unit.

FIG. 14 is a diagram illustrating an example of processing in a case where a target frequency band is set so as to include all of a plurality of frequencies included in a spectrogram.

FIG. 15 is a diagram illustrating an example of processing in a case where a target frequency band is set so as to include only a part of a plurality of frequencies included in a spectrogram.

FIG. 16 illustrates an autocorrelation function calculated for a change, with time, of an overall sound pressure of frequencies included in a target frequency band of “0 to 861 Hz.”

FIG. 17 illustrates an autocorrelation function calculated for a change, with time, of an overall sound pressure of frequencies included in a target frequency band of “861 to 1722 Hz.”

FIG. 18 illustrates an autocorrelation function calculated for a change, with time, of an overall sound pressure of frequencies included in a target frequency band of “1722 to 2583 Hz.”

FIG. 19 is a diagram illustrating an example of a procedure of a diagnostic process performed by a sound diagnostic system according to Embodiment 2.

FIG. 20 is a diagram illustrating an example of period candidate information.

FIG. 21 is a block diagram illustrating a hardware configuration of a computer that functions as a server or a diagnostic apparatus.

### DETAILED DESCRIPTION OF EMBODIMENTS

Hereinafter, one or more embodiments of the present invention will be described with reference to the drawings. However, the scope of the invention is not limited to the disclosed embodiments.

Hereinafter, embodiments of the technical idea according to the present disclosure are described with reference to the drawings. In the following description, the same components are denoted by the same reference characters. Their names and functions are the same. Therefore, a detailed description thereof is not herein repeated. Furthermore, each embodiment and each modification or the like may be selectively combined as appropriate.

### A. Application Example

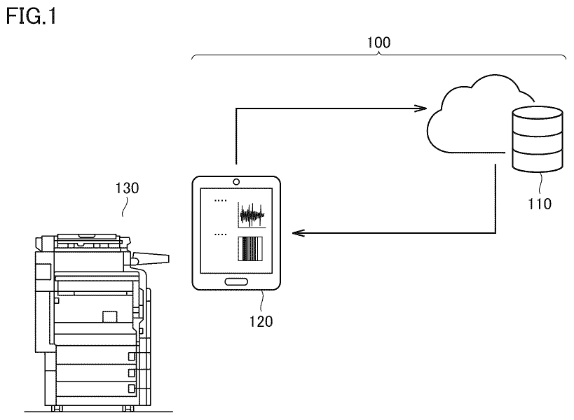

FIG. 1 is a diagram illustrating an example of a configuration of a sound diagnostic system to which the technology of the present disclosure is applicable. With reference to FIG. 1, a description is given of an outline of a sound diagnostic system 100 to which the technology of the present disclosure is applicable, and problems in a sound diagnosis. In addition, terms used in the present specification are described.

(a. Configuration of a System to which the Technology of the Present Disclosure is Applicable)

The sound diagnostic system 100 includes, by way of example, a diagnostic apparatus 120 and a server 110. According to an embodiment, the diagnostic apparatus 120 may have the function of the server 110. An apparatus 130 is a subject on which a sound diagnosis is to be conducted. The apparatus 130 is any equipment that includes a plurality of driven components. Examples of the apparatus 130 include office equipment such as an image forming apparatus, home appliances, equipment in a factory, research equipment, and the like. The diagnostic apparatus 120 is communicably connected to the server 110 via a wireless local area network (LAN) terminal such as a Wi-Fi (registered trademark) router, or via an Internet communication network.

The diagnostic apparatus 120 collects sound information on a sound produced by the apparatus 130, and displays a result of an analysis of the sound information. A serviceperson carries the diagnostic apparatus 120 in order to perform maintenance management, repair, and the like of an apparatus to be maintained, which is used by an end user. The diagnostic apparatus 120 acquires at least an abnormal sound produced by the apparatus to be maintained, and displays a result of an analysis of the acquired abnormal sound. The result of the analysis of the abnormal sound indicates a causative component that causes the abnormal sound, among a plurality of components included in the apparatus 130.

According to an embodiment, the diagnostic apparatus 120 transmits sampled sound information to the server 110. Then, the diagnostic apparatus 120 receives a result of an analysis from the server 110. Further, the diagnostic apparatus 120 displays the result of the analysis on a display. The result of the analysis indicates at least a causative component causing the abnormal sound. The diagnostic apparatus 120 and the server 110 are connected to each other via a wireless or wired network so as to be able to transmit and receive data to and from each other.

According to another embodiment, the diagnostic apparatus 120 analyzes the sampled sound information. Then, the diagnostic apparatus 120 displays the result of the analysis on the display. The result of the analysis indicates at least a causative component causing the abnormal sound. In this case, the sound diagnostic system 100 may not include the server 110.

According to still another embodiment, the diagnostic apparatus 120 is a tablet, a smartphone, a personal computer, smart glasses, or any other information processing apparatus. The diagnostic apparatus 120 may contain a normal microphone, a directional microphone, or the like. The diagnostic apparatus 120 may be configured in such a manner that a normal microphone or a directional microphone is connectable to the diagnostic apparatus.

The server 110 receives the sound information from the diagnostic apparatus 120 via the network. The server 110 analyzes the sound information and returns a result of the analysis to the diagnostic apparatus 120. The result of the analysis indicates a causative component causing the abnormal sound. A procedure for analyzing the sound information is described in detail later herein. According to an embodiment, the server 110 may be implemented as one or more apparatuses, a virtual machine built on a cloud environment, or a combination thereof.

The apparatus 130 is an apparatus to be diagnosed. The apparatus 130 includes a plurality of driven components. The driven component is a component driven by a motor, for example. Sounds produced by respective driven components may have respective frequencies different from each other.

(b. Problems that May Occur in Sound Diagnosis)

As described above, the apparatus 130 includes a plurality of driven components. For example, an image forming apparatus used in an office or the like includes numerous driven components. Therefore, even when the diagnostic apparatus 120 collects an abnormal sound, it is not easy to identify a driven component producing the abnormal sound. In order to solve this problem, the sound diagnostic system 100 calculates a sound pressure of each of the plurality of frequencies, from sound information on the sound produced by the apparatus 130. The sound diagnostic system 100 calculates an autocorrelation function for a change, with time, of a representative value of the sound pressures of respective frequencies included in a target frequency band. The sound diagnostic system 100 extracts one or more peak timings of the autocorrelation function. The sound diagnostic system 100 detects a period of each of one or more abnormal sounds, based on the one or more peak timings. The sound diagnostic system 100 identifies, based on the detected period, a causative component for each of one or more abnormal sounds, among a plurality of driven components included in the apparatus 130.

(c. Terms Used in the Present Specification)

Next, terms used herein to describe the technology of the present disclosure are described.

“System” in the present specification encompasses a configuration formed of one or multiple apparatuses. The system may also encompass a virtual machine or a container built in a cloud environment, or a configuration formed of at least a part of them.

“Apparatus” in the present specification may be any information processing apparatus such as a personal computer, a workstation, a server apparatus, a tablet, or a smartphone. The apparatus may also be a combination of them.

According to an embodiment, the sound diagnostic system 100 may be connected to input/output devices such as a display and a keyboard, and used by a user. According to another embodiment, the sound diagnostic system 100 may provide various functions to a user via a network, as a service or web application. In this case, the user may use the functions of the sound diagnostic system 100 via a browser or client software installed in a terminal of the user.

“Apparatus to be diagnosed” in the present specification encompasses an apparatus installed in any place such as a home, an office, a factory, a school, or a laboratory. By way of example, the apparatus to be diagnosed is any apparatus such as a refrigerator, an air conditioner, an image forming apparatus, a manufacturing apparatus placed in a factory, or a robot. The apparatus to be diagnosed includes a plurality of driven components. In the present specification, the apparatus to be diagnosed may be referred to simply as apparatus.

“Component (driven component)” in the present specification is a component included in an apparatus to be diagnosed. The component is typically a rotationally driven component. The component may be a motor or a combination of a motor and a power transmission component. The component may also be a combination of a motor, a power transmission component, and a component located downstream thereof. Alternatively, the component may be a component driven by a motor.

“Sound information” in the present specification relates to a sound produced by an apparatus to be diagnosed. The sound information may also be data picked up by the diagnostic apparatus 120 through a microphone, that is, sampled sound data. The sampled sound data is digital data represented at any resolution.

“Sound pressure” in the present specification is a deviation from the atmospheric pressure caused by a sound. The sound pressure is defined as an effective value of the maximum amplitude.

“Overall sound pressure (overall sound intensity)” in the present specification is a representative value of sound pressures of respective frequency components included in a target frequency band, at each timing of a spectrogram. An overall sound pressure (a representative value of sound pressures) is, for example, a sum or an average value. The spectrogram includes a plurality of frequency components for each timing. For example, it is assumed that frequency components X, Y, and Z are included in the target frequency band, at timing A of the spectrogram. In this case, the overall sound pressure (overall sound intensity) at timing A is calculated by an equation: “overall sound pressure at timing A=a sound pressure of frequency component X+a sound pressure of frequency component Y+a sound pressure of frequency component Z.” Alternatively, the overall sound pressure (overall sound intensity) at timing A may be an average value of the sound pressures of respective frequency components X, Y, and Z.

“Autocorrelation function” in the present specification indicates a relationship between a time shift amount τ and an autocorrelation between a time waveform x(t) of an overall sound pressure (a representative value of sound pressures) and a waveform x(t+τ) obtained by shifting x(t) by the time shift amount τ. “Autocorrelation” represents the degree of similarity between the waveform x(t) and the waveform x(t+τ). “Autocorrelation” is also referred to as “autocorrelation coefficient.”

When x(t) is a discrete signal, the autocorrelation function R(τ) is typically expressed by the following Expression (1). Note that the autocorrelation function R(τ) may be normalized using the mean and the variance of x(t) so as to have a value of −1 to 1.

$$R ( τ ) = \frac{1}{N} {\sum }_{t}^{N} x ( t ) \cdot x ( t + τ ) \qquad ( 1 )$$

“Peak timing” in the present specification is a timing having an autocorrelation higher than an autocorrelation at a preceding timing and an autocorrelation at a subsequent timing, by a certain extent or more, in a autocorrelation graph.

### B. Embodiment 1

(a. Apparatus Configuration)

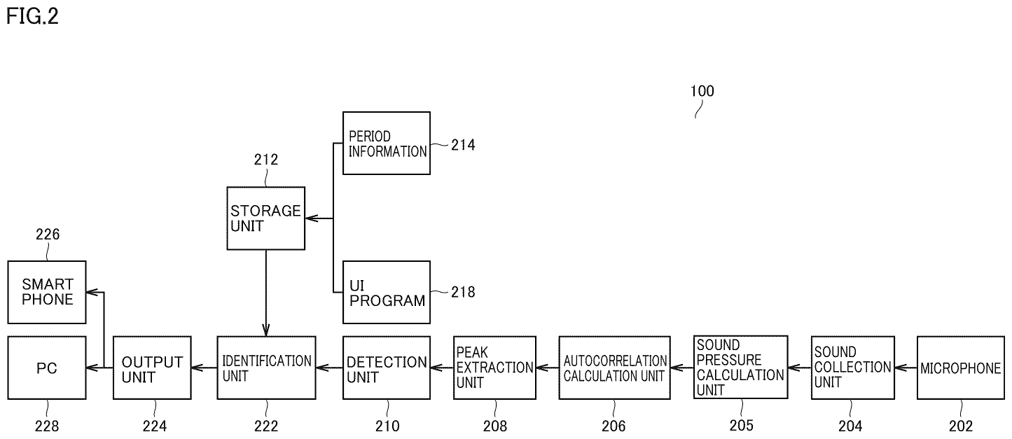

FIG. 2 is a diagram illustrating an example of a configuration of the sound diagnostic system according to Embodiment 1. A part or all of the components illustrated in FIG. 2 may be implemented as hardware. Some of the components illustrated in FIG. 2 may also be implemented as software. In this case, the sound diagnostic system 100 includes one or more hardware processors for executing each software component, one or more memories, and one or more storages.

The sound diagnostic system 100 includes a microphone (mic) 202, a sound collection unit 204, a sound pressure calculation unit 205, an autocorrelation calculation unit 206, a peak extraction unit 208, and a detection unit 210. Furthermore, the sound diagnostic system 100 includes a storage unit 212, an identification unit 222, and an output unit 224. The storage unit 212 stores period information 214 and a user interface (UI) program 218.

According to an aspect, the diagnostic apparatus 120 includes the microphone 202, the sound collection unit 204, and the output unit 224. The server 110 includes the sound pressure calculation unit 205, the autocorrelation calculation unit 206, the peak extraction unit 208, the detection unit 210, the storage unit 212, and the identification unit 222.

According to another aspect, the diagnostic apparatus 120 may have the function of the server 110 in addition to the microphone (mic) 202, the sound collection unit 204, and the output unit 224. In this case, the diagnostic apparatus 120 includes the sound pressure calculation unit 205, the autocorrelation calculation unit 206, the peak extraction unit 208, the detection unit 210, the storage unit 212, and the identification unit 222.

The microphone 202 and the sound collection unit 204 operate as a collection unit that collects sound information on a sound produced by the apparatus.

The microphone 202 converts a sound into an electrical signal and outputs the electrical signal to the sound collection unit 204. The apparatus 130 includes a plurality of sound sources (driven components). Therefore, the microphone 202 picks up a synthesized sound produced by a plurality of sound sources.

The sound collection unit 204 converts the electrical signal output from the microphone 202 into a digital signal to generate sound information (a sampling result). The sound collection unit 204 converts an analog signal into sound information that is a digital signal at any resolution. The sound collection unit 204 outputs the generated sound information.

The sound pressure calculation unit 205 is an example of “first calculation unit” in the present disclosure. The sound pressure calculation unit 205 calculates a sound pressure of each of a plurality of frequencies included in each timing of sound information. More specifically, the sound pressure calculation unit 205 performs a short-time Fourier transform (STFT) on the sound information (sound data). The sound pressure calculation unit 205 performs the STFT on the sound information to thereby obtain a frequency spectrum waveform (spectrogram). The spectrogram represents a change, with time, in sound pressure distribution for each frequency.

The sound pressure calculation unit 205 calculates, for each timing, an overall sound pressure (a representative value of sound pressures) of frequencies included in the target frequency band, among the plurality of frequencies. The overall sound pressure is, for example, the sum or the average value of the sound pressures of respective frequencies. The target frequency band may include all of the plurality of frequencies at which the sound pressure is calculated by the sound pressure calculation unit 205, or may include only a part of the plurality of frequencies.

The autocorrelation calculation unit 206 is an example of “second calculation unit” in the present disclosure. The autocorrelation calculation unit 206 calculates an autocorrelation function for a change, with time, in overall sound pressure (a representative value of sound pressures) of frequencies included in a target frequency band. That is, the autocorrelation calculation unit 206 calculates an autocorrelation function for the time waveform x(t) of the overall sound pressure of the frequencies included in the target frequency band. The autocorrelation calculation unit 206 calculates an autocorrelation between the time waveform x(t) and the time waveform x(t+τ) obtained by shifting the time waveform x(t) by the time shift amount τ. The autocorrelation calculation unit 206 calculates an autocorrelation function R(τ) representing a relationship between the time shift amount τ and the autocorrelation, while changing the time shift amount τ within a predetermined range. The autocorrelation calculation unit 206 is described in detail later herein with reference to FIG. 7.

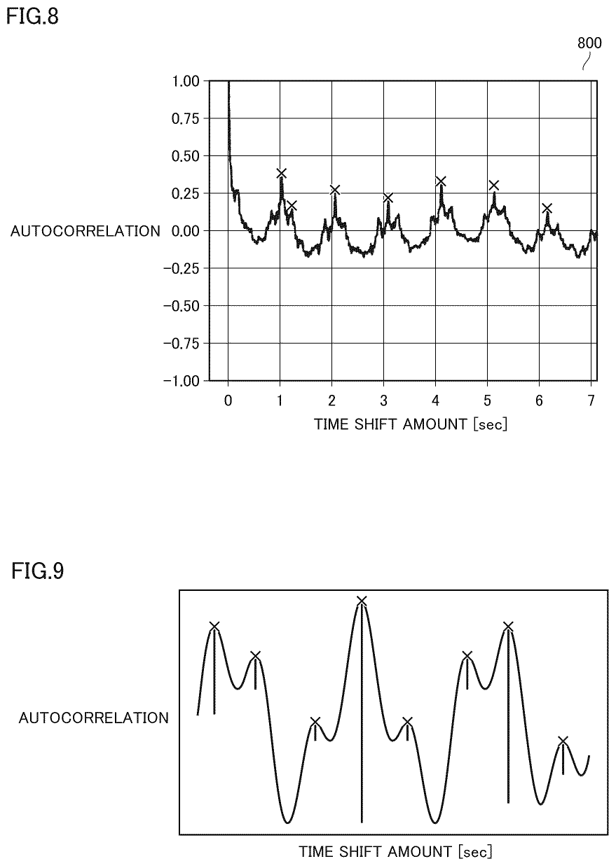

The peak extraction unit 208 extracts one or more peak timings of the autocorrelation function R(τ). More specifically, the peak extraction unit 208 extracts, as a peak timing, a time shift amount τ at which an autocorrelation differs from adjacent autocorrelations at respective timings by a preset value or more. Alternatively, the peak extraction unit 208 may extract the peak timing based on a prominence value (a degree of projection) of the autocorrelation. The peak extraction unit 208 is described in detail later herein with reference to FIGS. 8 and 9.

The detection unit 210 detects the period of each of one or more abnormal sounds, based on one or more peak timings. For example, the detection unit 210 detects, as a period, a peak timing at which the height of the peak (prominence value) is largest among the extracted one or more peak timings. Alternatively, when a plurality of peak timings are extracted, the detection unit 210 may detect the period of an abnormal sound based on the interval between peak timings. For example, when the peak timing 1.5 sec and the peak timing 3.0 sec are extracted, the detection unit 210 may determine that the period is 3.0−1.5=1.5 sec.

The detection unit 210 may detect respective periods of a plurality of abnormal sounds, from a plurality of peak timings. For example, the detection unit 210 detects, as a period of a first abnormal sound, the shortest peak timing among the plurality of peak timings. Then, the detection unit 210 extracts, from the plurality of peak timings, one or more remaining peak timings at which the difference from an integer multiple of the period of the first abnormal sound exceeds a threshold value. The detection unit 210 detects, as a period of the second abnormal sound, the shortest peak timing among the extracted one or more remaining peak timings. The detection unit 210 may detect the period of the k-th abnormal sound by repeating the same process. k is an integer of 3 or more.

The storage unit 212 stores data required for processing by the identification unit 222 and data of a UI to be provided to a user. The storage unit 212 stores period information 214. The period information 214 indicates the period of a sound produced by each driven component. The storage unit 212 stores the UI program 218. The UI program 218 is data or a program of a UI to be provided to a user. The UI program 218 includes UI design data, an event program associated with each UI component, and the like.

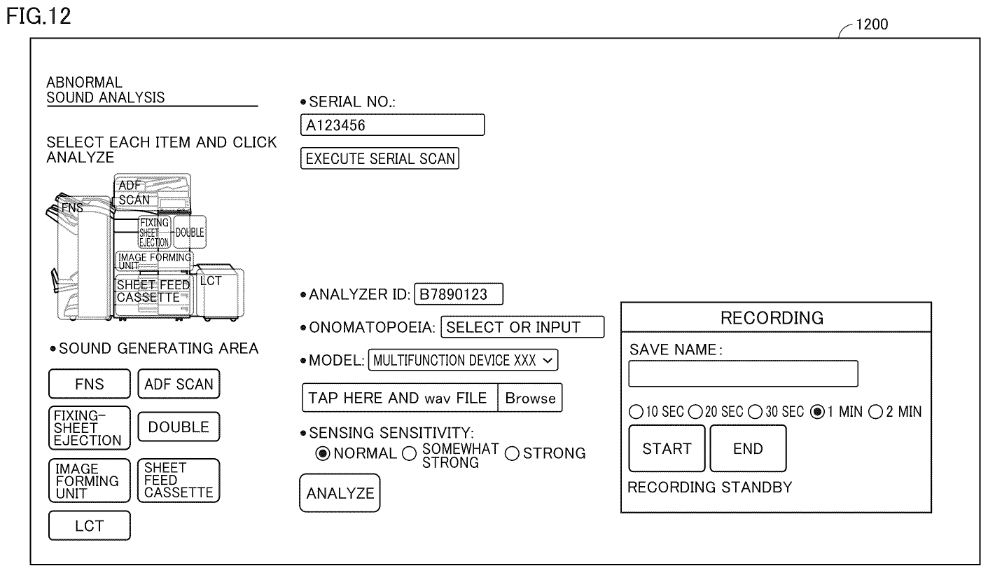

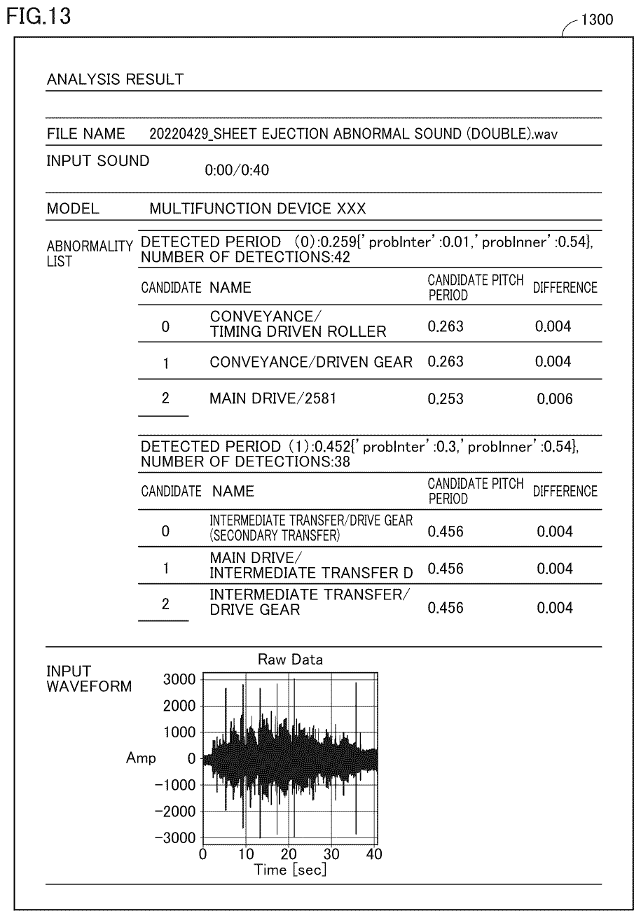

The output unit 224 outputs a result of an analysis of the sound information. The result of the analysis indicates at least a causative component causing the abnormal sound. By way of example, the output unit 224 displays the screens illustrated in FIG. 12 and FIG. 13 on the display of the diagnostic apparatus 120. Alternatively, the output unit 224 may transmit display data to another smartphone 226, personal computer (PC) 228, or any other apparatus.

(b. Procedure of Sound Diagnosis)

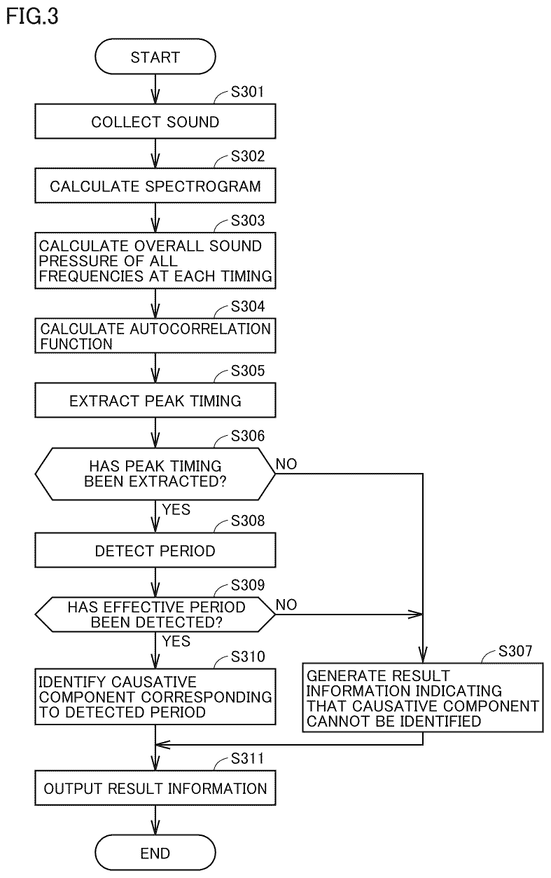

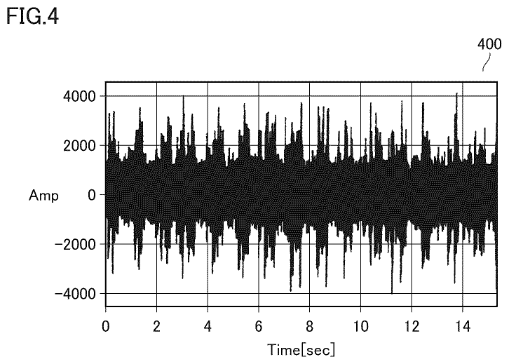

FIG. 3 is a diagram illustrating an example of a procedure of a diagnostic process performed by the sound diagnostic system according to Embodiment 1. An outline of the diagnostic process of the sound diagnostic system 100 is described with reference to FIG. 3. Details of each operation in FIG. 3 are described later herein with reference to FIGS. 4 to 13. According to an aspect, a hardware processor of the sound diagnostic system 100 may read a program for performing the process in FIG. 3, from a storage into a memory, and execute the program. In another aspect, a part or the whole of the process may be implemented as a combination of circuit elements configured to perform the process.

In step S301, the diagnostic apparatus 120 picks up a sound of the apparatus 130 to be diagnosed through a microphone (microphone 202). More specifically, the microphone 202 of the diagnostic apparatus 120 picks up a sound produced by the apparatus 130, in response to a user's (e.g., a serviceperson's) operation. In addition, the sound collection unit 204 converts the sound (an analog signal) into sampled sound information (digital data). The diagnostic apparatus 120 transmits the sound information to the server 110. In connection with the following steps, it is assumed that the sound information is to be transmitted to the server 110. Note that in one aspect in which the diagnostic apparatus 120 additionally has the function of the server 110, the diagnostic apparatus 120 does not transmit the sound information to the server 110. By way of example, the diagnostic apparatus 120 acquires sound information 400 as illustrated in FIG. 4.

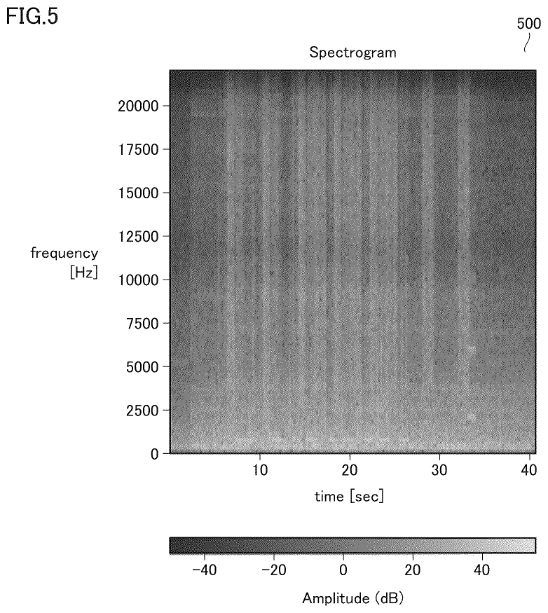

In step S302, the server 110 performs STFT on the acquired sound information. Thus, the server 110 calculates a spectrogram representing a change, with time, in sound pressure distribution for each frequency. By way of example, the server 110 acquires a spectrogram 500 as illustrated in FIG. 5.

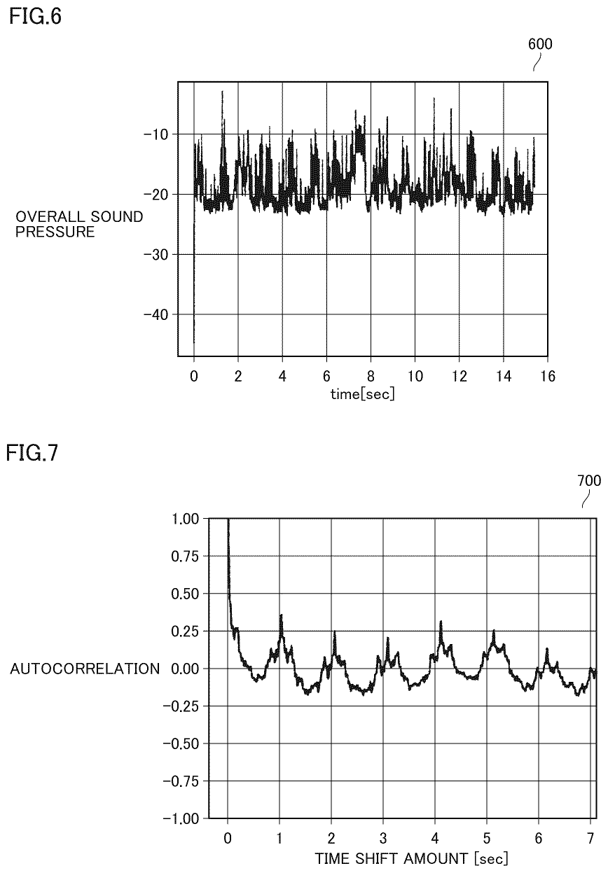

In step S303, the server 110 calculates, for each timing, an overall sound pressure (a representative value of sound pressures) of all of a plurality of frequencies included in the spectrogram. Typically, the server 110 calculates, as the overall sound pressure, the sum of the sound pressures of respective frequencies for each timing in the spectrogram. Alternatively, the server 110 calculates, as the overall sound pressure, the average value of the sound pressures of respective frequencies for each timing in the spectrogram. By way of example, the server 110 acquires data 600 as illustrated in FIG. 6. Data 600 indicates the overall sound pressure for each timing.

In step S304, the server 110 calculates an autocorrelation function for a change, with time, in overall sound pressure. By way of example, the server 110 calculates an autocorrelation function 700 as illustrated in FIG. 7. The autocorrelation function 700 indicates a relationship between the time shift amount τ and the autocorrelation.

In step S305, the server 110 extracts one or more peak timings of the autocorrelation function. The peak timing is a timing at which the autocorrelation is larger than those of the preceding and following timings by a certain degree or more, in the graph of the autocorrelation. In other words, it is a portion protruding to a greater extent in the graph of the autocorrelation. By way of example, the server 110 acquires peak timing information 800 indicating peak timings as illustrated in FIG. 8.

In step S306, the server 110 determines whether one or more peak timings have been extracted.

When one or more peak timings have not been extracted (NO in step S306), the process proceeds to step S307. In step S307, the server 110 generates result information indicating that the causative component of the abnormal sound cannot be identified.

When one or more peak timings have been extracted (NO in step S306), the process proceeds to step S308. In step S308, the server 110 detects a period of each of one or more abnormal sounds, on the basis of one or more peak timings indicated by the peak timing information 800.

In step S309, the server 110 determines whether a period effective for identifying a causative component of the abnormal sound has been detected. For example, the server 110 determines that a period having a difference from any period indicated by the period information 214 that is less than a predetermined threshold value is an effective period.

When the period effective for identifying the causative component of the abnormal sound is not detected (NO in step S309), the process proceeds to step S307.

When the period effective for identifying the causative component of the abnormal sound is detected (YES in step S309), the process proceeds to step S310. In step S310, the server 110 identifies, as a causative component, a driven component that produces a sound with a period different from the detected period by a predetermined threshold value or less, based on the period information 214. The server 110 generates result information indicating the identified causing component.

After step S307 or step S310, the process proceeds to step S311. In step S311, the server 110 transmits the result information to the diagnostic apparatus 120. The diagnostic apparatus 120 displays the result indicated by the received result information on a display. According to an aspect, the diagnostic apparatus 120 may transfer the result information to another apparatus (such as a PC or a smartphone).

(c. Details of Each Procedure)

Next, details of each operation of the flow in FIG. 3 are described with reference to FIGS. 4 to 13. More particularly, the operations in steps S301 to S311 are described in detail with reference to FIGS. 4 to 13.

FIG. 4 is a diagram illustrating an example of sound information. The sound information 400 is an example of the sound information acquired in step S301. The sound information 400 represents a sound pressure for each time.

FIG. 5 is a diagram illustrating an example of the spectrogram. The spectrogram 500 is an example of the acquired spectrogram calculated in step S302. The sound diagnostic system 100 calculates the spectrogram 500 by performing STFT on the sound information 400. The sound information 400 includes a plurality of frequency components. That is, the sound information is a set of a plurality of sounds having different frequencies. STFT is performed on the sound information 400 to generate the spectrogram 500 indicating a change, with time, in sound pressure distribution of each frequency component. In other words, the spectrogram 500 includes information on the various sounds produced by respective components of the apparatus 130.

FIG. 6 is a diagram illustrating an example of data of the overall sound pressure for a target frequency band for each timing in the spectrogram. The data 600 illustrated in FIG. 6 is an example of the data calculated in step S303. The data 600 indicates a change, with time, in overall sound pressure (representative value of sound pressures) of all frequency components included in the spectrogram 500. The overall sound pressure is the sum or the average value of the sound pressures of all frequency components.

FIG. 7 is a diagram illustrating an example of an autocorrelation function. An autocorrelation function 700 illustrated in FIG. 7 is an example of the autocorrelation function calculated in step S304. The autocorrelation function 700 is calculated for the time waveform x(t) indicated by the data 600 illustrated in FIG. 6.

For example, the time waveform x(t) is expressed as a discrete function corresponding to a time resolution Δt of the spectrogram calculated by the sound pressure calculation unit 205. Δt is, for example, 0.005 sec. In this case, the autocorrelation calculation unit 206 calculates an autocorrelation between the time waveform x(t) and the time waveform x(t+n×Δt). n is a natural number and is also referred to as a lag. The time shift amount τ is represented by n×Δt. The autocorrelation calculation unit 206 calculates the autocorrelation function 700 by changing the lag n within a predetermined range.

Note that it is also possible to calculate an autocorrelation function for the sound information 400 illustrated in FIG. 4. However, the volume of the data 600 illustrated in FIG. 6 is smaller than the volume of the sound information 400 illustrated in FIG. 4. Therefore, a calculation load for calculating an autocorrelation function for the data 600 illustrated in FIG. 6 is smaller than a calculation load for calculating an autocorrelation function for the sound information 400 illustrated in FIG. 4.

Furthermore, in order to further reduce the calculation load for calculating the autocorrelation function 700, the range of the time shift amount τ may be determined depending on the maximum rotation period that can be taken by a plurality of components of the apparatus 130. For example, when the maximum period indicated by the period information 214 is three seconds, three seconds or a time slightly longer than three seconds is determined as the upper limit value of the range of the time shift amount τ. The server 110 calculates the autocorrelation function 700 by changing the time shift amount τ in a range from 0 to the upper limit value.

When a periodic abnormal sound is generated by a driven component, the overall sound pressure for each time has periodicity. In this case, as illustrated in FIG. 7, periodic peaks appear in the autocorrelation function 700. Therefore, the peak timing corresponds to the period of the abnormal sound.

It is preferable that the server 110 removes a trend component from the change with time indicated by the data 600, in order to more accurately determine the period of the abnormal sound. The trend component represents a tendency of data over a long period of time, such as a certain increasing tendency or decreasing tendency, which occurs with passage of time. Therefore, the server 110 removes the trend component, for example, by applying a high-pass filter to the data 600. The server 110 may calculate an autocorrelation function for a change, with time, in the overall sound pressure from which the trend component has been removed.

FIG. 8 is a diagram illustrating an example of peak timing information. The peak timing information 800 illustrated in FIG. 8 is an example of peak timing information indicating one or more peak timings extracted in step S305. The peak timing information 800 indicates the peak timing of the autocorrelation function 700 illustrated in FIG. 7.

The server 110 (peak extraction unit 208) changes the time shift amount τ from 0 to the upper limit value successively, and determines whether a target time shift amount is a peak timing.

Specifically, the server 110 (peak extraction unit 208) compares an autocorrelation for the target time shift amount with an autocorrelation for an adjacent time shift amount. It is assumed that the autocorrelation for the target time shift amount is higher than the autocorrelation for the adjacent time shift amount by a predetermined threshold value or more. In this case, the server 110 (peak extraction unit 208) determines that the target time shift amount is a peak timing. The server 110 acquires the autocorrelation at that time as a peak value. In FIG. 8, “x” represents a peak.

Note that the server 110 may exclude a peak representing an autocorrelation equal to or less than a preset threshold value (for example, 0.1). The server 110 extracts, as a peak timing, a time shift amount τ for the peak is left without being excluded.

FIG. 9 is a diagram illustrating an example of prominences of peaks of an autocorrelation. The server 110 (peak extraction unit 208) may detect a peak timing of the autocorrelation based on the prominence value (a degree of projection) of the peak. The prominence is a method for calculating the degree of projection of each peak, in accordance with the relative position of a certain peak and the relative position of another peak.

A specific method of calculating the prominence is as follows. First, the server 110 focuses on a certain peak. Next, the server 110 extends rightward and leftward the horizontal line of the peak, until the horizontal line of the peak intersects with a higher peak or reaches the right or left end (graph end) of the signal. Next, the server 110 finds signals of which autocorrelations are a minimum value, on the right side and the left side of a section where the horizontal line is extended. Next, the server 110 sets a larger one of the minimum value of the right section and the minimum value of the left section, as a reference value. Next, the server 110 sets a difference between the autocorrelation of the peak and the reference value, as a prominence value. The prominence value indicates the degree of projection from the surroundings (the height of the peak relative to the surroundings). The server 110 excludes peaks equal to or smaller than a predetermined prominence value (e.g., 0.1). The server 110 extracts, as the peak timing, the time shift amount τ of the peak that is left without being excluded.

Note that the server 110 may impose a limitation on the length of left and right extensions of the horizontal line in order to calculate a more accurate prominence value.

According to an aspect, after detecting the target time shift amount as the peak timing, the server 110 may not detect the time shift amount in a certain period from the peak timing as a peak timing. Thus, successive detection of peaks due to noise is suppressed.

According to an aspect, the server 110 may restrict the one or more peak timings based on peak information. The peak information indicates the shape of the peak. The peak information indicates, for example, the height of the peak (the value of the autocorrelation or prominence value), the kurtosis of the peak, or the difference or ratio between the autocorrelation of the peak and the maximum value of the autocorrelation. For example, the server 110 excludes, from the peak timing, a time shift amount having an autocorrelation of which difference from the maximum value of the autocorrelation is less than or equal to a predetermined threshold value (for example, a value half the maximum value). Thus, the time shift amount having a smaller autocorrelation is not erroneously detected as the peak timing. Alternatively, the server 110 may exclude, from the peak timing, a time shift amount by which the height of the peak is equal to or smaller than a predetermined threshold value. Alternatively, the server 110 may exclude, from the peak timing, a time shift amount by which the kurtosis of the peak is equal to or smaller than a predetermined threshold.

The server 110 (the detection unit 210) detects the period of each of one or more abnormal sounds on the basis of one or more peak timings.

The identification unit 222 checks the detected period with the period information 214 to identify a causative component causing the abnormal sound.

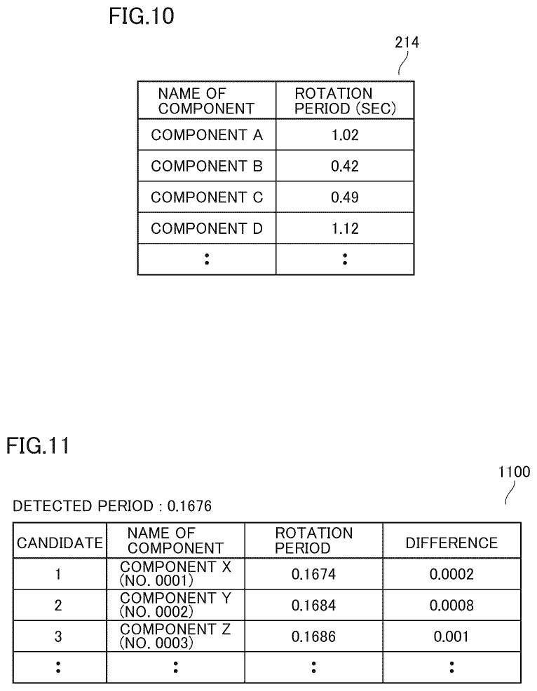

FIG. 10 is a diagram illustrating an example of period information. As illustrated in FIG. 10, period information 214 associates each of a plurality of driven components included in the apparatus 130, with a rotation period. According to an aspect, the period information 214 may be expressed as a table of a relational database. The period information 214 may also be expressed in any other data format such as JSON (JavaScript (registered trademark) Object Notation).

FIG. 11 is a diagram illustrating an example of result information indicating causative components identified by the identification unit. The identification unit 222 checks a detected period against respective periods of the components included in the period information 214. The identification unit 222 searches for a component that produces a sound having a rotation period close to the detected period.

For example, the result information 1100 illustrated in FIG. 11 is generated when the detected period is “0.1676 sec” and the rotation period of the component X is “0.1674 sec.” Since the detected period “0.1676 sec” and the rotation period “0.1674 sec” of the component X are close to each other, the identification unit 222 selects the component X as a candidate for the causative component of an abnormal sound having the detected period “0.1676 sec.”

According to an aspect, the identification unit 222 may select a plurality of components as candidates for the causative component of the abnormal sound having the detected period. For example, as illustrated in FIG. 11, when the detected period is close to the rotation periods of components X, Y, and Z, the identification unit 222 may select the components X, Y, and Z as candidates for the causative component of the abnormal sound having the detected period.

By way of example, the identification unit 222 may determine that a component p is a candidate for a causative component of an abnormal sound having a detected period, based on the following Expressions (2) to (5).

$$p = arg {min}_{j ∈ P} ( abs ( {T}_{i} - {T}_{j} ) ) \qquad ( 2 )$$

$${T}_{i} = detected period \qquad ( 3 )$$

$$P = list of periods of searched components \qquad ( 4 )$$

$${T}_{j} = period of component j \qquad ( 5 )$$

FIG. 12 is a diagram illustrating an example of a first screen output by the output unit. According to an aspect, the first screen 1200 is displayed on the display of the diagnostic apparatus 120. According to another aspect, the output unit 224 transmits data of the first screen 1200 to another apparatus (smartphone 226, PC 228, or the like). The other apparatus displays the data of the first screen 1200 on a display. The first screen 1200 is generated by the UI program 218.

The first screen 1200 is a screen before sound diagnosis is conducted. The first screen 1200 includes buttons or the like for parameter settings necessary for analysis, and for execution of recording and analysis. On the first screen 1200, a user (serviceperson or the like) may select a sound file (information on collected sound) and press an analysis button to acquire an analysis result. When the analysis button is pressed, the first screen 1200 transitions to a second screen 1300.

FIG. 13 is a diagram illustrating an example of the second screen output by the output unit. According to an aspect, the second screen 1300 is displayed on the display of the diagnostic apparatus 120. According to another aspect, the output unit 224 transmits data of the second screen 1300 to another apparatus (smartphone 226, PC 228, or the like). The other apparatus displays the data of the second screen 1300 on a display. The second screen 1300 is generated by the UI program 218.

The second screen 1300 is a screen showing a result of an analysis of the sound file (information on collected sound). The second screen 1300 displays the period of an abnormal sound detected based on the peak timing of the autocorrelation function, and the name of a component that produces a sound having a period close to the period of the abnormal sound. The second screen 1300 may display a plurality of component names when there are a plurality of components that generate a sound having a period close to the period of the detected abnormal sound.

### C. Embodiment 2

As described above, the target frequency band for which the overall sound pressure is calculated may include all of a plurality of frequencies included in the spectrogram 500. Alternatively, the target frequency band for which the overall sound pressure is calculated may include only a part of the plurality of frequencies included in the spectrogram 500.

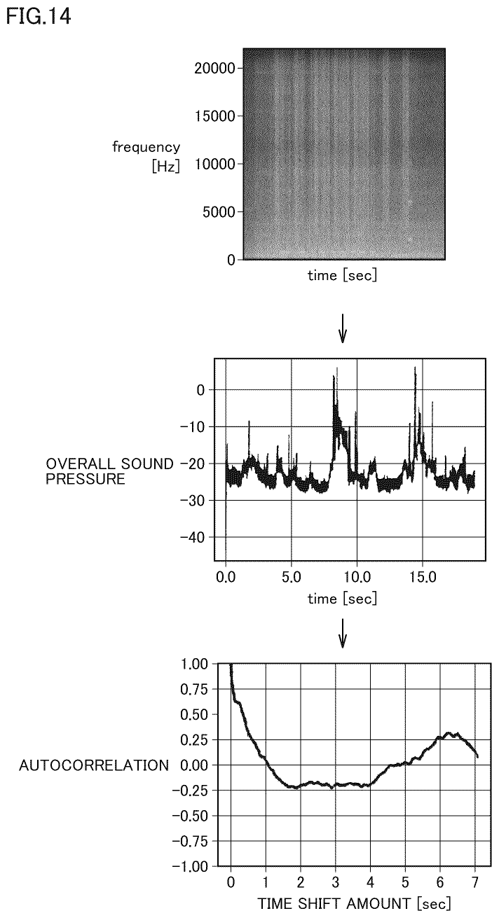

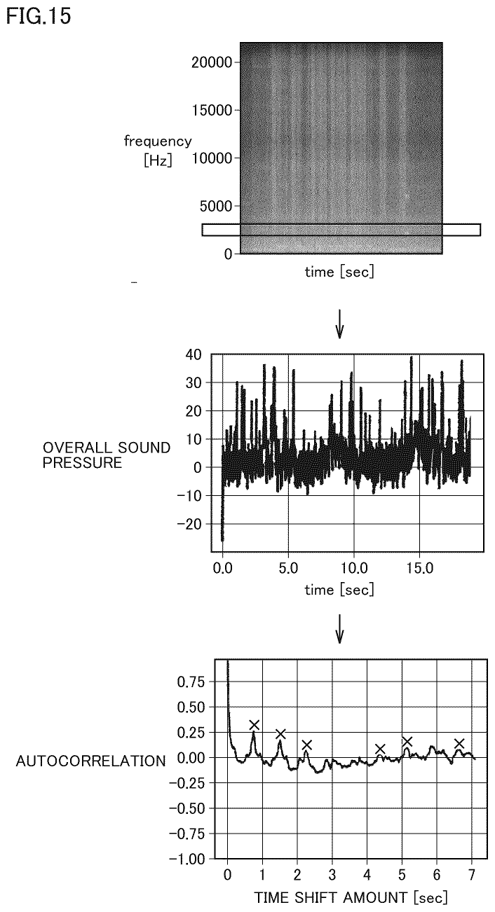

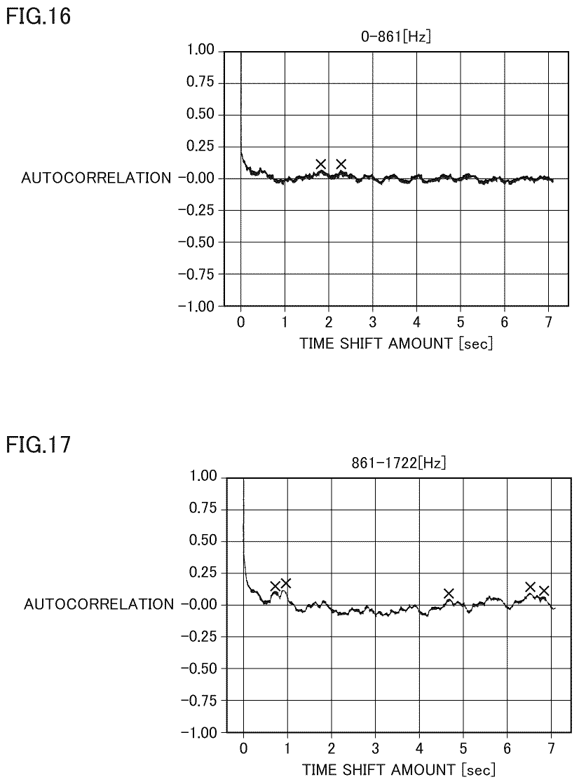

FIG. 14 is a diagram illustrating an example of processing in a case where the target frequency band is set so as to include all of a plurality of frequencies included in the spectrogram. FIG. 15 is a diagram illustrating an example of processing in a case where the target frequency band is set so as to include only a part of a plurality of frequencies included in the spectrogram. In FIGS. 14 and 15, the top plot illustrates a spectrogram. The middle plot illustrates a change with time (time waveform) of the overall sound pressure. The bottom plot illustrates an autocorrelation function.

For example, an image forming apparatus includes a plurality of rollers. An abnormal sound such as a rubbing sound produced by the rollers has only some frequency components and has a low sound pressure. Therefore, when the overall sound pressure is calculated for all frequency components, the abnormal sound having only some of the frequency components is buried in environmental sounds having other frequency components. Thus, as illustrated in FIG. 14, no peak of the autocorrelation function is detected when the overall sound pressure is calculated for all the frequency components included in the spectrogram. In contrast, as illustrated in FIG. 15, when the overall sound pressure is calculated for some of the frequency components, peaks of the autocorrelation function are detected.

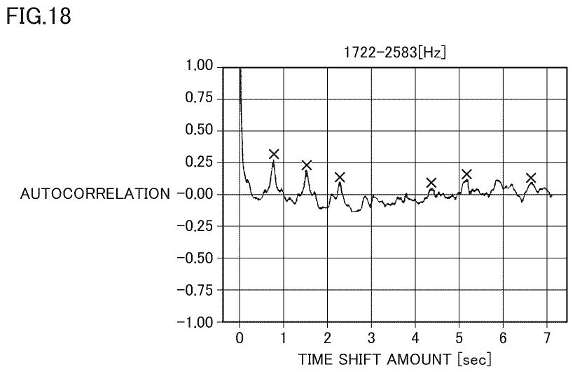

FIG. 16 illustrates an autocorrelation function calculated for a change, with time, in overall sound pressure of frequencies included in a target-frequency band of “0 to 861 Hz.” FIG. 17 illustrates an autocorrelation function calculated for a change, with time, in overall sound pressure of frequencies included in a target frequency band of “861 to 1722 Hz.” FIG. 18 illustrates an autocorrelation function calculated for a change, with time, in overall sound pressure of frequencies included in a target frequency band of “1722 to 2583 Hz.”

As illustrated in FIGS. 16 to 18, the three autocorrelation functions corresponding respectively to the three frequency bands are different from each other. Therefore, a sound diagnostic system according to Embodiment 2 identifies the period of each of one or more abnormal sounds by using a plurality of frequency bands. The sound diagnostic system according to Embodiment 2 has the same apparatus configuration as the sound diagnostic system 100 illustrated in FIG. 2. Therefore, the description of the apparatus configuration is not repeated for the sound diagnostic system according to Embodiment 2.

The sound diagnostic system according to Embodiment 2 presets a plurality of frequency bands. The plurality of frequency bands include a first frequency band and one or more second frequency bands. The first frequency band includes all of a plurality of frequencies included in the spectrogram. Each of the one or more second frequency bands includes only some of a plurality of frequencies included in the spectrogram. When the one or more second frequency bands include a plurality of second frequency bands, the plurality of second frequency bands are different from each other. Each of the one or more second frequency bands is a part of the first frequency band.

The one or more second frequency bands include, for example, frequency bands of “0 to 861 Hz,” “861 to 1722 Hz” and “1722 to 2583 Hz.”

Note that a certain second frequency band may partially overlap another second frequency band. For example, the one or more second frequency bands may include frequency bands of “0 to 861 Hz,” “761 to 1722 Hz” and “1622 to 2583 Hz.”

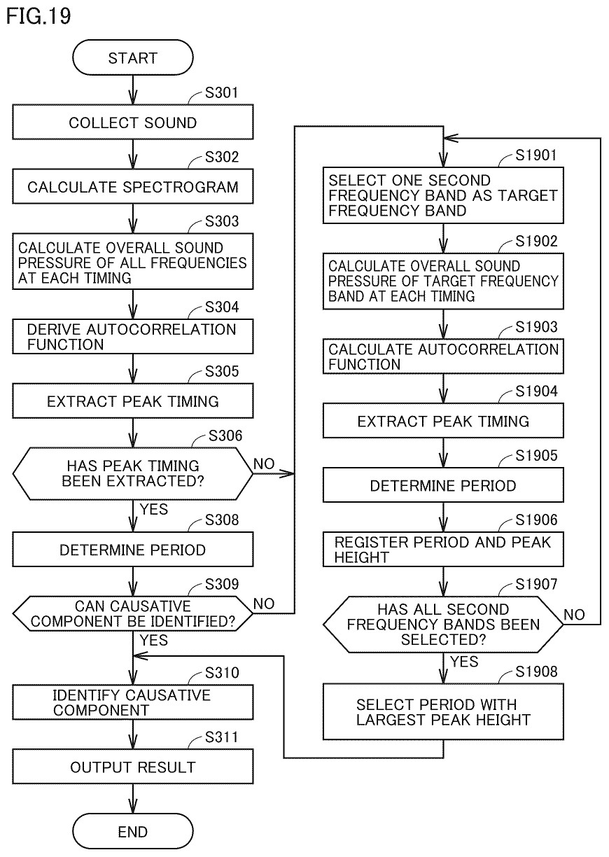

FIG. 19 is a diagram illustrating an example of a procedure of a diagnostic process performed by the sound diagnostic system according to Embodiment 2. The procedure illustrated in FIG. 19 is different from the procedure illustrated in FIG. 3 in that the former includes steps S1901 to S1908 instead of step S307. Therefore, the steps S1901 to S1908 are described in the following. Steps S1901 to S1908 are performed in the case of NO in step S306 or step S309. Note that in step S303, the first frequency band is set as a target frequency band. The first frequency band set as the target frequency band corresponds to “first target frequency band” in the present disclosure.

In step S1901, the server 110 (autocorrelation calculation unit 206) selects, as a target frequency band, an unselected one of the one or more second frequency bands. The second frequency band selected as the target frequency band corresponds to “second target frequency band” in the present disclosure.

In step S1902, the server 110 calculates, for each timing, an overall sound pressures (a representative values of sound pressures) of frequencies included in the target frequency band.

In step S1903, the server 110 calculates an autocorrelation function for a change, with time, of the overall sound pressure.

In step S1904, the server 110 (peak extraction unit 208) extracts one or more peak timings in the autocorrelation function.

In step S1905, the server 110 (detection unit 210) detects the period of each of one or more abnormal sounds on the basis of one or more peak timings.

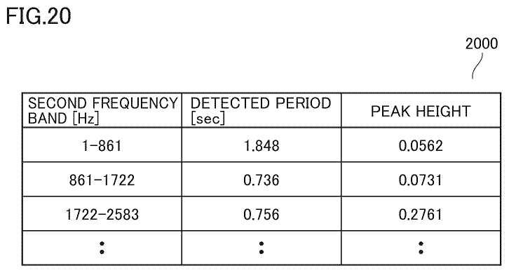

In step S1906, the server 110 registers, in period candidate information illustrated in FIG. 20, the detected period and the height of the peak of the peak timing corresponding to the period (hereinafter referred to as the “peak height”). The period candidate information is stored in the storage unit 212 illustrated in FIG. 2.

Note that when no peak timing is extracted in step S1904, steps S1905 and S1906 are skipped.

In step S1907, the server 110 determines whether all of the one or more second frequency bands have been selected each as a target frequency band.

When all of the one or more second frequency bands have not been selected each as a target frequency band (NO in step S1907), the process returns to step S1901.

When all of the one or more second frequency bands have been selected each as a target frequency band (YES in step S1907), the process proceeds to step S1908. In step S1908, the server 110 (identification unit 222) selects a period corresponding to the largest peak height from period candidate information.

After step S1908, the process proceeds to step S310. In step S310 subsequent to step S1908, the server 110 (identification unit 222) identifies a causative component. Specifically, the server 110 identifies, as a causative component, a driven component that produces a sound having a period different from the period selected in step S1908 by less than a predetermined threshold value.

FIG. 20 is a diagram illustrating an example of the period candidate information. The period candidate information 2000 illustrated in FIG. 20 indicates, for each of a plurality of second frequency bands, a detected period and a peak height at a peak timing corresponding to the period. The peak height is represented by, for example, an autocorrelation value or a prominence value. The period candidate information 2000 indicates “0.756 sec” as a period corresponding to the largest peak height. Therefore, in step S310, the server 110 identifies a component that produces a sound having a period close to the period “0.756 sec” as a causative component causing the abnormal sound.

Thus, the server 110 according to Embodiment 2 first calculates a first autocorrelation function corresponding to a frequency band including all of a plurality of frequencies included in the spectrogram. Then, in response to the fact that no causative component is identified based on the first autocorrelation function, the server 110 performs steps S1901 to S1908. Specifically, the server 110 calculates a second autocorrelation function corresponding to each of the one or more second frequency bands which are a part of the first frequency band. Then, the server 110 identifies a causative component based on the second autocorrelation function.

### D. Variations

Although the configuration in which the diagnostic apparatus 120 includes the microphone 202 is described herein, application examples of the technology of the present disclosure are not limited thereto. According to an aspect, the apparatus 130 to be diagnosed may include a microphone. In this case, the apparatus 130 transmits the sound information to the diagnostic apparatus 120 or the server 110.

The sound information may be analog sound data. In this case, the detection unit 210 may have a function of encoding analog sound data. The sound information may also be digital sound data. By way of example, the sound collection unit 204 may perform encoding or the like of a sound captured by the microphone 202. The sound information including a plurality of frequencies produced by the apparatus 130 may include a sampling result (sampling information) of a recorded sound. A predetermined period for extracting information on a plurality of sound pressures may be a period of any length set in advance in the sound diagnostic system 100. For example, the predetermined period may include a period of any length such as a few milliseconds, a few seconds, and a few minutes. The information on the sound pressures may include information such as the overall sound pressure of sounds of respective frequencies, a relative sound pressure of a sound of each frequency, and a peak timing included in the overall sound pressure.

In an aspect, the apparatus 130 may be an image forming apparatus including a plurality of drive sources. In this case, the plurality of drive sources may drive any of a fixing belt, a sheet ejection roller, a sheet feed roller, and a fixing gear.

In the present specification, timing may include not only an instant of time in a series of time but also a time (period) of any length. By way of example, the sound diagnostic system 100 may analyze sound information delimited every 1 microsecond. In this case, a certain timing means a period of one microsecond. Thus, the timing may be any period of time, such as one microsecond, one millisecond, or the like. The sound pressure within a certain period (e.g., a period of one microsecond) may for example be the average value or the median value of sound pressures within the period.

All or some of the sound pressure calculation unit 205, the autocorrelation calculation unit 206, the peak extraction unit 208, the detection unit 210, the storage unit 212, the identification unit 222, and the output unit 224 may be implemented by a computer.

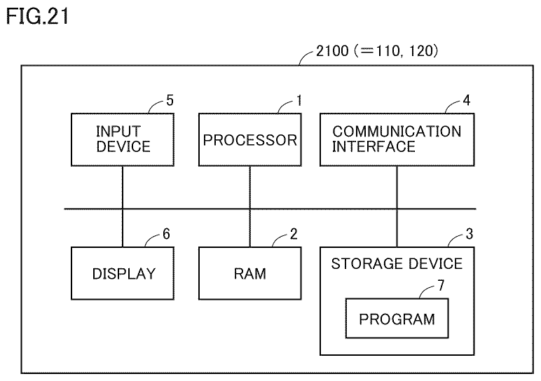

FIG. 21 is a block diagram illustrating a hardware configuration of a computer that functions as a server or a diagnostic apparatus. A computer 2100 illustrated in FIG. 21 includes, as main components, a processor 1, a memory (RAM (Random Access Memory)) 2, a storage device 3, a communication interface 4, an input device 5, and a display 6. These components are connected to one another by a data bus.

The processor 1 includes, for example, a CPU (central processing unit), an MPU (micro processing unit), or the like, and executes a program 7 stored in the storage device 3.

The RAM 2 stores, in a volatile manner, data generated through execution of the program 7 by the processor 1, data input via the input device 5, data externally received via the communication interface 4, and the like.

The storage device 3 stores data in a nonvolatile manner. The storage device 3 is implemented by a hard disk device, an SSD (solid state drive), or the like.

The input device 5 includes, for example, a touch panel, a keyboard, a mouse, and the like. The display 6 is, for example, a liquid crystal display or an organic EL (Electro Luminescence) display.

Processing in the computer 2100 is implemented through cooperation of the program 7 executed by each hardware device and the processor 1. The program 7 is stored in the storage device 3 in advance. Alternatively, the program 7 may be stored in a CD-ROM (Compact Disc-Read Only Memory) or another recording medium and distributed. Alternatively, the program 7 may also be provided as a downloadable application program by an information provider connected to the so-called Internet. Such a program 7 is read from the recording medium by an optical disc drive (not shown) or another reading device, or is downloaded via the communication interface 4, and then stored temporarily in the storage device 3.

Each component of the computer 2100 illustrated in FIG. 21 is a general one. Therefore, one of the essential parts of the technical idea according to the present disclosure can also be regarded as the program 7 stored in the RAM 2, the storage device 3, a CD-ROM or another recording medium, or the program 7 downloadable via a network. The recording medium may include a non-transitory (non-volatile) computer-readable data recording medium. Note that since the operation of each hardware device of the computer 2100 is well known, the detailed description is not repeated herein.

Note that the recording medium is not limited to a CD-ROM, an FD (Flexible Disk), and a hard disk, but may be a magnetic tape, a cassette tape, an optical disc (MO (Magnetic Optical Disc)/MD (Mini Disc)/DVD (Digital Versatile Disc)), an IC (Integrated Circuit) card (including a memory card), an optical card, or a medium carrying the program in a stationary manner like a semiconductor memory such as a mask ROM, an EPROM (Electronically Programmable Read-Only Memory), an EEPROM (Electronically Erasable Programmable Read-Only Memory), or a flash ROM.

The program 7 includes not only a program directly executable by the processor 1 but also a program in the form of a source program, a compressed program, an encrypted program, and the like.

### E. Supplementary Notes

As described above, the present embodiment includes the following disclosure.

### [Configuration 1]

A sound diagnostic system including:
a first calculation unit that calculates, from sound information on a sound produced by an apparatus, a sound pressure of each of a plurality of frequencies at each timing;
a second calculation unit that calculates an autocorrelation function for a change, with time, of a representative value of the sound pressures of respective frequencies included in a target frequency band, among the plurality of frequencies;
an extraction unit that extracts one or more peak timings of the autocorrelation function;
a detection unit that detects a period of each of one or more abnormal sounds, based on the one or more peak timings; and
an identification unit that identifies, based on the period, a causative component for each of the one or more abnormal sounds, among a plurality of components included in the apparatus.

### [Configuration 2]

The sound diagnostic system according to configuration 1, wherein the target frequency band includes all of the plurality of frequencies or only a part of the plurality of frequencies.

### [Configuration 3]

The sound diagnostic system according to configuration 1, wherein
the second calculation unit
   calculates, as the autocorrelation function, a first autocorrelation function corresponding to a first target frequency band including all of the plurality of frequencies; and
   calculates a second autocorrelation function corresponding to each of one or more second target frequency bands that are a part of the first target frequency band, in response to a fact that the causative component is not identified based on the first autocorrelation function.

### [Configuration 4]

The sound diagnostic system according to any one of configurations 1 to 3, wherein the second calculation unit determines a range of a time shift amount of the autocorrelation function, in accordance with a maximum rotation period that the plurality of components can take.

### [Configuration 5]

The sound diagnostic system according to any one of configurations 1 to 4, wherein
the second calculation unit
   removes a trend component from the change, with time, of the representative value; and
   calculates the autocorrelation function for the change, with time, of the representative value from which the trend component has been removed.

### [Configuration 6]

The sound diagnostic system according to any one of configurations 1 to 5, wherein the extraction unit extracts a target time shift amount as one of the one or more peak timings, in response to a fact that an autocorrelation at the target time shift amount differs from respective autocorrelations preceding and subsequent to the target time shift amount by more than or equal to a predetermined threshold value.

### [Configuration 7]

The sound diagnostic system according to any one of configurations 1 to 6, wherein the extraction unit restricts the one or more peak timings based on peak information indicating a shape of a peak.

### [Configuration 8]

The sound diagnostic system according to any one of configurations 1 to 7, wherein the identification unit identifies the causative component, using period information that associates each of the plurality of components with a rotation period.

### [Configuration 9]

A sound diagnostic method including:
calculating, from sound information on a sound produced by an apparatus, a sound pressure of each of a plurality of frequencies at each timing;
calculating an autocorrelation function for a change, with time, of a representative value of the sound pressures of respective frequencies included in a target frequency band, among the plurality of frequencies;
extracting one or more peak timings of the autocorrelation function;
detecting a period of each of one or more abnormal sounds, based on the one or more peak timings; and
identifying, based on the period, a causative component for each of the one or more abnormal sounds, among a plurality of components included in the apparatus.

### [Configuration 10]

A sound diagnostic program that causes a computer to perform a sound diagnostic method, the sound diagnostic method includes:
calculating, from sound information on a sound produced by an apparatus, a sound pressure of each of a plurality of frequencies at each timing;
calculating an autocorrelation function for a change, with time, of a representative value of the sound pressures of respective frequencies included in a target frequency band, among the plurality of frequencies;
extracting one or more peak timings of the autocorrelation function;
detecting a period of each of one or more abnormal sounds, based on the one or more peak timings; and
identifying, based on the period, a causative component for each of the one or more abnormal sounds, among a plurality of components included in the apparatus.

It should be understood that the embodiments disclosed herein are illustrative and non-restrictive in every respect. The scope of the present disclosure is defined not by the above description but by the appended claims, and all changes that come within the meaning and range of equivalency of the claims are intended to be embraced therein. In addition, it is intended that the disclosed contents described in the embodiment and the modifications can be implemented alone or in combination as much as possible.

Although embodiments of the present invention have been described and illustrated in detail, the disclosed embodiments are made for purposes of illustration and example only and not limitation. The scope of the present invention should be interpreted by terms of the appended claims.

What is claimed is:

1. A sound diagnostic system comprising:
one or more hardware processors; and
one or more memories storing instructions that, when executed by the one or more hardware processors, cause the one or more hardware processors to perform operations, the operations comprising:
calculating, from sound information on a sound produced by an apparatus, a sound pressure of each of a plurality of frequencies at each timing;
calculating an autocorrelation function for a change, with time, of a representative value of the sound pressures of respective frequencies included in a target frequency band, among the plurality of frequencies;
extracting one or more peak timings of the autocorrelation function;
detecting a period of each of one or more abnormal sounds, based on the one or more peak timings; and
identifying, based on the period, a causative component for each of the one or more abnormal sounds, among a plurality of components included in the apparatus.

2. The sound diagnostic system according to claim 1, wherein the target frequency band includes all of the plurality of frequencies or only a part of the plurality of frequencies.

3. The sound diagnostic system according to claim 1, wherein
calculating the autocorrelation function includes:
calculating, as the autocorrelation function, a first autocorrelation function corresponding to a first target frequency band including all of the plurality of frequencies; and
calculating a second autocorrelation function corresponding to each of one or more second target frequency bands that are a part of the first target frequency band, in response to a fact that the causative component is not identified based on the first autocorrelation function.

4. The sound diagnostic system according to claim 1, wherein calculating the autocorrelation function includes determining a range of a time shift amount of the autocorrelation function, in accordance with a maximum rotation period that the plurality of components can take.

5. The sound diagnostic system according to claim 1, wherein calculating the autocorrelation function includes:
removing a trend component from the change, with time, of the representative value; and
calculating the autocorrelation function for the change, with time, of the representative value from which the trend component has been removed.

6. The sound diagnostic system according to claim 1, wherein extracting the one or more peak timings includes extracting a target time shift amount as one of the one or more peak timings, in response to a fact that an autocorrelation at the target time shift amount differs from respective autocorrelations preceding and subsequent to the target time shift amount by more than or equal to a predetermined threshold value.

7. The sound diagnostic system according to claim 1, wherein extracting the one or more peak timings includes restricting the one or more peak timings based on peak information indicating a shape of a peak.

8. The sound diagnostic system according to claim 1, wherein identifying the causative component includes identifying the causative component, using period information that associates each of the plurality of components with a rotation period.

9. A sound diagnostic method comprising:
calculating, from sound information on a sound produced by an apparatus, a sound pressure of each of a plurality of frequencies at each timing;
calculating an autocorrelation function for a change, with time, of a representative value of the sound pressures of respective frequencies included in a target frequency band, among the plurality of frequencies;
extracting one or more peak timings of the autocorrelation function;
detecting a period of each of one or more abnormal sounds, based on the one or more peak timings; and
identifying, based on the period, a causative component for each of the one or more abnormal sounds, among a plurality of components included in the apparatus.

10. A non-transitory computer-readable recording medium storing instructions that cause a computer to perform a sound diagnostic method, the sound diagnostic method comprising:
calculating, from sound information on a sound produced by an apparatus, a sound pressure of each of a plurality of frequencies at each timing;
calculating an autocorrelation function for a change, with time, of a representative value of the sound pressures of respective frequencies included in a target frequency band, among the plurality of frequencies;
extracting one or more peak timings of the autocorrelation function;
detecting a period of each of one or more abnormal sounds, based on the one or more peak timings; and
identifying, based on the period, a causative component for each of the one or more abnormal sounds, among a plurality of components included in the apparatus.
